(19) United States
(12) Patent Application Publication
(10) Pub. No.: US 2026/0159679 A1
(43) Pub. Date: Jun. 11, 2026

(54) RUBBER CROSSLINKED PRODUCT AND VIBRATION-PROOF MEMBER

(71) Applicants: DAIDO KOGYO CO., LTD., Ishikawa (JP); TEIJIN FRONTIER CO., LTD., Osaka (JP)

(72) Inventors: Noriaki YAMAMOTO, Ishikawa (JP); Ko YONEDA, Osaka (JP); Mie KAMIYAMA, Osaka (JP); Daisuke KUNISADA, Osaka (JP); Shintaro SHIMADA, Osaka (JP)

(21) Appl. No.: 19/405,915

(22) Filed: Dec. 2, 2025

(30) Foreign Application Priority Data
Dec. 5, 2024 (JP) 2024-212028

(51) Int. Cl. C08L 23/16; C08K 3/04; C08K 3/22; C08K 5/09; C08K 5/14; C08K 5/18; C08K 5/378; F16F 7/00

(52) U.S. Cl. CPC C08L 23/16; C08K 3/04; C08K 5/09; C08K 5/14; C08K 5/18; C08K 5/378; F16F 7/00; C08K 2003/2296; C08L 2205/03; C08L 2205/16; F16F 2224/025

(57) ABSTRACT

The rubber crosslinked product contains a rubber component containing one or more polymers of ethylene propylene diene rubber and ethylene butene diene rubber; polyethylene compatibilized with the rubber component; and a plurality of polyethylene terephthalate fibers having a diameter of 100 nm or more and 1000 nm or less and a length of 0.1 mm or more and 50 mm or less, in which a content of the polyethylene is 0.05 parts by mass or more and 5.0 parts by mass or less with respect to 100 parts by mass of the rubber component, and a total content of the plurality of polyethylene terephthalate fibers is 0.15 parts by mass or more and 5.0 parts by mass or less with respect to 100 parts by mass of the rubber component.

### FIELD OF INVENTION

The present invention relates to a rubber crosslinked product contributing to improvement in steering stability and a vibration-proof member including the same.

### BACKGROUND ART

A vibration-proof member is widely used in various applications for the purpose of suppressing vibration generated from a vibrating body. In particular, in mobility-related fields such as automobiles in general, two-wheeled vehicles, and railways, various vibration-proof members are used for the purpose of suppressing noise of automobiles and the like, improving ride comfort, enhancing steering stability, and the like. For such a vibration-proof member, various rubber crosslinked products that are favorably used for vibration-proof applications are used in consideration of the physical properties of the crosslinked product itself, the type of rubber component, the type of additive, the blending ratio of the additive, and the like.

For example, JP 2001-011263 A describes a vibration-proof rubber composition containing a butyl rubber, an EPDM having a Mooney viscosity ML1+8 (100° C.) of about 50 to 100, and a sulfur-based vulcanization accelerator. Specifically, it is described that the vibration-proof rubber composition has a hardness and a dynamic magnification of a certain value or less, and can provide a vulcanizate suitably used as a vibration-proof material.

### SUMMARY OF THE INVENTION

An object of the present invention is to provide a rubber crosslinked product having a high storage modulus and a low loss factor from the low frequency range to the high frequency range.

As a result of intensive studies to solve the above problems, the present inventors have reached the present invention.

A rubber crosslinked product according to a first aspect of the present invention contains a rubber component containing one or more polymers of ethylene propylene diene rubber and ethylene butene diene rubber; polyethylene compatibilized with the rubber component; and a plurality of polyethylene terephthalate fibers having a diameter of 100 nm or more and 1000 nm or less and a length of 0.1 mm or more and 50 mm or less, in which a content of the polyethylene is 0.05 parts by mass or more and 5.0 parts by mass or less with respect to 100 parts by mass of the rubber component, and a total content of the plurality of polyethylene terephthalate fibers is 0.15 parts by mass or more and 5.0 parts by mass or less with respect to 100 parts by mass of the rubber component.

### BRIEF DESCRIPTION OF THE DRAWINGS

FIG. 1 is a schematic view showing a composite material composed of polyethylene and a plurality of polyethylene terephthalate fibers as raw materials of a rubber crosslinked product according to the present embodiment.

FIG. 2 is a graph showing storage moduli of samples of a rubber crosslinked product of Example 1 in the grain direction and the opposite grain direction at each frequency.

FIG. 3 is a graph showing storage moduli of samples of a rubber crosslinked product of Comparative Example 1 in the grain direction and the opposite grain direction at each frequency.

FIG. 4 is a graph showing storage moduli of samples of a rubber crosslinked product of Example 2 in the grain direction and the opposite grain direction at each frequency.

FIG. 5 is a graph showing storage moduli of samples of a rubber crosslinked product of Comparative Example 2 in the grain direction and the opposite grain direction at each frequency.

FIG. 6 is a graph showing storage moduli of samples of a rubber crosslinked product of Example 3 in the grain direction and the opposite grain direction at each frequency.

FIG. 7 is a graph showing storage moduli of samples of a rubber crosslinked product of Comparative Example 3 in the grain direction and the opposite grain direction at each frequency.

FIG. 8 is a graph showing a comparison of the storage moduli between the sample of the rubber crosslinked product of Example 1 and the sample of the rubber crosslinked product of Comparative Example 1 in the grain direction at each frequency.

FIG. 9 is a graph showing a comparison of loss factors between the sample of the rubber crosslinked product of Example 1 and the sample of the rubber crosslinked product of Comparative Example 1 in the grain direction at each frequency.

FIG. 10 is a graph showing a comparison of the storage moduli between the sample of the rubber crosslinked product of Example 2 and the sample of the rubber crosslinked product of Comparative Example 2 in the grain direction at each frequency.

FIG. 11 is a graph showing a comparison of loss factors between the sample of the rubber crosslinked product of Example 2 and the sample of the rubber crosslinked product of Comparative Example 2 in the grain direction at each frequency.

FIG. 12 is a graph showing a comparison of the storage moduli between the sample of the rubber crosslinked product of Example 3 and the sample of the rubber crosslinked product of Comparative Example 3 in the grain direction at each frequency.

FIG. 13 is a graph showing a comparison of loss factors between the sample of the rubber crosslinked product of Example 3 and the sample of the rubber crosslinked product of Comparative Example 3 in the grain direction at each frequency.

FIG. 14 is a part of a cross-sectional image of the sample of the rubber crosslinked product of Example 3 observed using a digital microscope.

### DETAILED DESCRIPTION

The effect of steering stability by the rubber crosslinked product for vibration often depends on the frequency. Specifically, steering stability by a specific one type of rubber crosslinked product shows different behavior in the low frequency range and in the high frequency range. However, in the vibration-proof rubber composition described in JP 2001-011263 A, the hardness and dynamic magnification of the vulcanizate are not measured in consideration of the frequency difference. Therefore, it is preferable to have a rubber crosslinked product that can exhibit an effect of improved steering stability from the low frequency range to the high frequency range.

The steering stability of the rubber crosslinked product for vibration is evaluated by dynamic viscoelasticity of the rubber crosslinked product, specifically, storage modulus and loss factor. Conventionally, in order to increase the storage modulus, it has been studied to contain reinforcing fibers in a rubber crosslinked product. However, there is a problem that reinforcing fibers are not well dispersed during kneading a rubber material, and a rubber crosslinked product containing reinforcing fibers which is preferable for vibration-proof applications has not been reported.

As a result of intensive studies by the present inventors, it has been found that a rubber crosslinked product having a high storage modulus and a low loss factor from the low frequency range to the high frequency range can be obtained by adding a composite material having a sea-island structure composed of polyethylene and a plurality of polyethylene terephthalate fibers having a predetermined size to a rubber component at a predetermined blending ratio to produce a rubber crosslinked product. In the obtained rubber crosslinked product, it has been found that polyethylene derived from the composite material is compatibilized with the rubber component. Further, accordingly, it has been also found that a plurality of polyethylene terephthalate fibers (hereinafter, also referred to as “PET fibers”) derived from the composite material are dispersed (preferably substantially uniformly dispersed) in the rubber component and the polyethylene.

Such a rubber crosslinked product of the present invention has a high storage modulus and a low loss factor from the low frequency range to the high frequency range.

In the present specification, the “rubber crosslinked product” means a molded body (crosslinked product or vulcanizate) obtained by blending raw materials of a rubber composition and crosslinking (or vulcanizing) the mixture with a crosslinking agent (or vulcanizing agent). The shape of the rubber crosslinked product is not particularly limited. For example, the shape of the rubber crosslinked product may be any shape that can be used for producing any vibration-proof member (vibration-proof product) known to those skilled in the art, such as a sheet shape, a polygonal shape, a circular shape, a cylindrical shape, and a conical shape.

In the present specification, the “storage modulus” and the “loss factor” mean values of storage modulus (Pa) and loss factor (tan δ), respectively, measured by frequency dependence measurement of a dynamic viscoelasticity test using a dynamic viscoelasticity measuring device “Rheogel-E4000” manufactured by UBM, as described in detail in the following Examples. Furthermore, in the present specification, the phrase “from the low frequency range to the high frequency range” means a frequency range including at least a range of 0 Hz to 200 Hz, and preferably a frequency range of a range of 0 Hz to 400 Hz.

Hereinafter, embodiments of the present invention will be described in detail. The scope of the present invention is not limited to the embodiments described herein, and various modifications can be made without impairing the gist of the present invention.

### <Rubber Crosslinked Product>

The rubber crosslinked product according to the present embodiment includes a rubber component, polyethylene compatibilized with the rubber component, and a plurality of PET fibers. The polyethylene and the plurality of PET fibers are components derived from a composite material composed of polyethylene and a plurality of PET fibers as raw materials. Hereinafter, the components contained in the rubber crosslinked product and the physical properties of the rubber crosslinked product will be described in detail.

### (Rubber Component)

The rubber crosslinked product according to the present embodiment contains, as a rubber component, one or more polymers of ethylene propylene diene rubber (hereinafter, also referred to as “EPDM”) and ethylene butene diene rubber (hereinafter, also referred to as “EBDM”).

The type of EPDM is not particularly limited, and may be any EPDM known to those skilled in the art, which is generally used as an industrial rubber material. Specifically, as EPDM, any of polymers obtained by copolymerizing ethylene and propylene with a small amount of various non-conjugated diene components can be used. As the non-conjugated diene, for example, 5-ethylidene-2-norbornene, 5-vinyl-2-norbornene rubber, dicyclopentadiene, 1,4-hexadiene, or the like is used.

The ethylene content in EPDM is not particularly limited as long as the effect on dynamic viscoelasticity from a low frequency to a high frequency in the present embodiment is not impaired. For example, the ethylene content in EPDM is preferably 30 wt % or more and 80 wt % or less, and more preferably 40 wt % or more and 70 wt % or less.

The molecular weight of EPDM is not particularly limited as long as the effect on dynamic viscoelasticity from a low frequency to a high frequency in the present embodiment is not impaired. For example, the molecular weight of EPDM is preferably 200,000 to 1 million from the viewpoint of a balance between durability and working efficiency.

The EPDM as a rubber component may be synthesized by a known method, or a commercially available product may be used. Examples of commercially available EPDM include “ESPRENE 6373” (amount of ethylene: 65 wt %, manufactured by Sumitomo Chemical Co., Ltd.), “ESPRENE 552” (amount of ethylene: 55 wt %, manufactured by Sumitomo Chemical Co., Ltd.), “KELTAN 2450” (amount of ethylene: 48 wt %, manufactured by Lanxess), “PX-008M” (amount of ethylene: 60 wt %, manufactured by Mitsui Chemicals, Inc.), and the like.

Also, the type of EBDM is not particularly limited, and may be any EBDM known to those skilled in the art, which is generally used as an industrial rubber material. Specifically, as EBDM, any of polymers obtained by copolymerizing ethylene and butene with a small amount of various non-conjugated diene components can be used. As the non-conjugated diene, for example, 5-ethylidene-2-norbornene, 5-vinyl-2-norbornene rubber, dicyclopentadiene, 1,4-hexadiene, or the like is used.

The molecular weight of EBDM is also not particularly limited as long as the effect on dynamic viscoelasticity from a low frequency to a high frequency in the present embodiment is not impaired. For example, the molecular weight of EBDM is preferably 200,000 to 1 million from the viewpoint of a balance between durability and work efficiency.

The ethylene content in EBDM is not particularly limited as long as the effect on dynamic viscoelasticity from a low frequency to a high frequency in the present embodiment is not impaired. For example, the ethylene content in EBDM is preferably 30 wt % or more and 80 wt % or less, and more preferably 40 wt % or more and 60 wt % or less.

The EBDM as a rubber component may be synthesized by a known method, or a commercially available product may be used. Examples of commercially available EBDM include “EBT K-9330M” (amount of ethylene: 50 wt %, manufactured by Mitsui Chemicals, Inc.), and the like.

The polymers of EPDM and EBDM as rubber components may be used alone, or may be used in combination of two or more thereof.

In addition, the rubber component preferably contains one or more polymers selected from the group consisting of ethylene propylene 5-ethylidene-2-norbornene rubber, ethylene propylene vinylidene 5-vinyl-2-norbornene rubber, and ethylene butene 5-ethylidene-2-norbornene rubber. When one or more polymers selected from any one of these polymers are contained, a rubber crosslinked product having a high storage modulus and a low loss factor from the low frequency range to the high frequency range can be obtained more reliably.

The content of the rubber component in the rubber crosslinked product may be appropriately adjusted within a range that satisfies the conditions of the content of polyethylene and a plurality of PET fibers derived from a composite material as raw materials described later, in consideration of the type of the rubber component and other components contained, and without impairing the effect on dynamic viscoelasticity from a low frequency to a high frequency in the present embodiment. For example, the content of the rubber component is preferably 10 parts by mass or more and 75 parts by mass or less, and more preferably 20 parts by mass or more and 65 parts by mass or less with respect to the total amount of the rubber crosslinked product.

### (Polyethylene)

The rubber crosslinked product according to the present embodiment contains polyethylene derived from a composite material composed of polyethylene and a plurality of PET fibers as raw materials. Polyethylene is compatibilized with the rubber component in the rubber crosslinked product.

In the present specification, the phrase “polyethylene is compatibilized with the rubber component” means that polyethylene and a rubber component, which are separate at the time of raw materials, are melted by heating during rubber kneading, so that the polyethylene and the rubber component are mixed together in the finally obtained rubber crosslinked product and the polyethylene and the rubber component cannot be distinguished from each other. Specifically, it means that the polyethylene and the rubber component cannot be distinguished from each other when the cross section of the rubber crosslinked product according to the embodiment is observed with a scanning electron microscope (SEM).

The content of the polyethylene is 0.05 parts by mass or more and 5.0 parts by mass or less with respect to 100 parts by mass of the rubber component. When the content of the polyethylene is 0.05 parts by mass or more, a plurality of PET fibers can be well dispersed in the rubber component and the polyethylene. When the content of the polyethylene is 5.0 parts by mass or less, it is possible to prevent the original elasticity of the rubber component from being impaired and to obtain a rubber crosslinked product having desired physical properties.

The content of the polyethylene is preferably 0.50 parts by mass or more, more preferably 1.0 part by mass or more, further preferably 1.5 parts by mass or more, and particularly preferably 1.7 parts by mass or more, with respect to 100 parts by mass of the rubber component. Also, the content of the polyethylene is preferably 4.5 parts by mass or less, more preferably 4.0 parts by mass or less, further preferably 3.5 parts by mass or less, and particularly preferably 3.0 parts by mass or less, with respect to 100 parts by mass of the rubber component.

### (Plurality of PET Fibers)

The rubber crosslinked product according to the present embodiment contains a plurality of PET fibers derived from a composite material composed of polyethylene and a plurality of PET fibers as raw materials. Each fiber of the plurality of PET fibers has a diameter of 100 nm or more and 1000 nm or less and a length of 0.1 mm or more and 50 mm or less.

The plurality of PET fibers are dispersed, preferably substantially uniformly dispersed, in the rubber component and the polyethylene. In the present specification, the phrase “a plurality of PET fibers are dispersed in the rubber component and the polyethylene” means that each of PET fibers having polyethylene and a sea-island structure in the composite material at the time of raw materials spreads throughout the rubber component and the polyethylene when the cross section of a finally obtained rubber crosslinked product is observed using an SEM. When such a plurality of PET fibers having an extremely small diameter are dispersed (preferably substantially uniformly dispersed) in the rubber component and the polyethylene, a rubber crosslinked product having a high storage modulus and a low loss factor from the low frequency range to the high frequency range can be reliably obtained.

The diameter of PET fibers is preferably 200 nm or more, more preferably 300 nm or more, further preferably 400 nm or more, and particularly preferably 500 nm or more or 600 nm or more. Also, the diameter of PET fibers is preferably 900 nm or less, more preferably 850 nm or less, further preferably 800 nm or less, and particularly preferably 750 nm or less or 700 nm or less.

In addition, when the length of PET fibers is 0.1 mm or more, the aspect ratio of PET fibers is high, so that the dynamic characteristics of the rubber crosslinked product in the grain direction can be enhanced. The length of PET fibers is preferably 0.3 mm or more, more preferably 0.4 mm or more, and particularly preferably 0.5 mm or more.

Furthermore, the length of PET fibers is preferably 30 mm or less, more preferably 20 mm or less, further preferably 15 mm or less, and particularly preferably 10 mm or less.

The total content of the plurality of PET fibers is 0.15 parts by mass or more and 5.0 parts by mass or less with respect to 100 parts by mass of the rubber component. When the total content of the plurality of PET fibers is 0.15 parts by mass or more, the storage modulus of the rubber crosslinked product can be increased and the loss factor can be decreased from the low frequency range to the high frequency range. When the total content of the plurality of PET fibers is 5.0 parts by mass or less, it is possible to prevent the original elasticity of the rubber component from being impaired and to obtain a rubber crosslinked product having desired physical properties.

The total content of the plurality of PET fibers is preferably 0.25 parts by mass or more, more preferably 1.0 part by mass or more, further preferably 1.5 parts by mass or more, and particularly preferably 1.8 parts by mass or more, with respect to 100 parts by mass of the rubber component. Also, the total content of the plurality of PET fibers is preferably 4.5 parts by mass or less, more preferably 4.0 parts by mass or less, further preferably 3.5 parts by mass or less, and particularly preferably 3.0 parts by mass or less, with respect to 100 parts by mass of the rubber component.

As described above, the polyethylene and the plurality of PET fibers are components derived from the composite material composed of polyethylene and a plurality of PET fibers as raw materials. Therefore, the total content of the polyethylene and the plurality of PET fibers is the content of the composite material composed of polyethylene and a plurality of PET fibers used as raw materials. The total content of the polyethylene and the plurality of PET fibers (the content of the composite material as raw materials) is 0.2 parts by mass or more and 10.0 parts by mass or less with respect to 100 parts by mass of the rubber component.

The mass ratio between the polyethylene and the plurality of PET fibers in the composite material as the raw materials is preferably polyethylene: PET fibers (mass ratio)=5:5 to 3:7.

### (Carbon Black)

The rubber crosslinked product according to the present embodiment preferably further contains carbon black. The carbon black functions as a reinforcing material for the rubber crosslinked product.

The type of carbon black is not particularly limited as long as it is any carbon black known to those skilled in the art to be added to the rubber crosslinked product. Examples of the type include furnace blacks such as channel black, SAF, ISAF, N-339, HAF, N-351, MAF, FEF, SRF, GPF, ECF, and N-234, thermal blacks such as FT and MT, acetylene blacks, and the like. The carbon black may be added alone, or may be added in combination of two or more thereof.

The content of the carbon black may be appropriately adjusted within a range that satisfies the conditions of the content of polyethylene and a plurality of PET fibers derived from a composite material as raw materials described above, in consideration of the type of the rubber component and other components contained, and without impairing the effect on dynamic viscoelasticity from a low frequency to a high frequency in the present embodiment. For example, the content of the carbon black is preferably 35 parts by mass or more and 200 parts by mass or less with respect to 100 parts by mass of the rubber component. When the content of the carbon black is 35 parts by mass or more, the mechanical strength, elongation and abrasion resistance of the rubber crosslinked product are improved, and a rubber crosslinked product having a particularly high storage modulus can be reliably obtained. When the content of the carbon black is 200 parts by mass or less, the dynamic viscoelasticity inherent to the rubber component can be favorably maintained.

The content of the carbon black is more preferably 40 parts by mass or more, further preferably 45 parts by mass or more, and particularly preferably 50 parts by mass or more, with respect to 100 parts by mass of the rubber component. In addition, the content of the carbon black is more preferably 150 parts by mass or less, further preferably 130 parts by mass or less, and particularly preferably 115 parts by mass or less, with respect to 100 parts by mass of the rubber component.

### (Optional Components)

The rubber crosslinked product according to the present embodiment may contain any other component known to those skilled in the art, which is generally added to the rubber crosslinked product. As such an optional component, for example, the rubber crosslinked product may further contain one or more components selected from the group consisting of a vulcanization accelerator aid, a processing aid, an anti-aging agent, a vulcanization accelerator, a crosslinking agent, a crosslinking aid, a filler, and an oil.

The vulcanization accelerator aid has a function of accelerating the formation of a crosslinked structure by a crosslinking agent or a vulcanizing agent. The type of the vulcanization accelerator aid is not particularly limited as long as it is any vulcanization accelerator aid known to those skilled in the art to be added to the rubber crosslinked product. Examples of the vulcanization accelerator aid include metal oxides such as magnesium oxide and zinc oxide, and the like. The vulcanization accelerator aid may be added alone, or may be added in combination of two or more thereof.

The content of the vulcanization accelerator aid may be appropriately adjusted within a range without impairing the effect on dynamic viscoelasticity from a low frequency to a high frequency in the present embodiment. For example, when the rubber crosslinked product contains a vulcanization accelerator aid, the content of the vulcanization accelerator aid is preferably 1.0 part by mass or more and 15 parts by mass or less, and more preferably 3.0 parts by mass or more and 8.0 parts by mass or less, with respect to 100 parts by mass of the rubber component.

The type of the processing aid is not particularly limited as long as it is any processing aid known to those skilled in the art to be added to the rubber crosslinked product. Examples of the processing aid include saturated fatty acids such as stearic acid, unsaturated fatty acids, and the like. The processing aid may be added alone, or may be added in combination of two or more thereof.

The content of the processing aid may also be appropriately adjusted within a range without impairing the effect on dynamic viscoelasticity from a low frequency to a high frequency in the present embodiment. For example, when the rubber crosslinked product contains a processing aid, the content of the processing aid is preferably more than 0 parts by mass and 3.0 parts by mass or less, and more preferably 0.5 parts by mass or more and 2.0 parts by mass or less, with respect to 100 parts by mass of the rubber component.

The type of the anti-aging agent is not particularly limited as long as it is any anti-aging agent known to those skilled in the art to be added to the rubber crosslinked product. Examples of the anti-aging agent include an amine-based anti-aging agent, an imidazole-based anti-aging agent, a phenol-based anti-aging agent, and the like. The anti-aging agent may be added alone, or may be added in combination of two or more thereof.

The content of the anti-aging agent may also be appropriately adjusted within a range without impairing the effect on dynamic viscoelasticity from a low frequency to a high frequency in the present embodiment. For example, when the rubber crosslinked product contains an anti-aging agent, the content of the anti-aging agent is preferably 1.0 part by mass or more and 8.0 parts by mass or less, and preferably 3.0 parts by mass or more and 6.0 parts by mass or less, with respect to 100 parts by mass of the rubber component.

The vulcanization accelerator has a function of accelerating the formation of a crosslinked structure by a crosslinking agent or a vulcanizing agent. The type of the vulcanization accelerator is not particularly limited as long as it is any vulcanization accelerator known to those skilled in the art to be added to the rubber crosslinked product. Examples of the vulcanization accelerator include guanidine-based, aldehyde-amine-based, aldehyde-ammonia-based, thiazole-based, sulfenamide-based, thiourea-based, thiuram-based, dithiocarbamate-based, and xanthate-based vulcanization accelerators. The vulcanization accelerator may be added alone, or may be added in combination of two or more thereof.

The content of the vulcanization accelerator may also be appropriately adjusted within a range without impairing the effect on dynamic viscoelasticity from a low frequency to a high frequency in the present embodiment. For example, when the rubber crosslinked product contains a vulcanization accelerator, the content of the vulcanization accelerator is preferably 0.1 parts by mass or more and 15 parts by mass or less, and more preferably 0.5 parts by mass or more and 10 parts by mass or less, with respect to 100 parts by mass of the rubber component.

The crosslinking agent (also including the vulcanizing agent) has a function of crosslinking a raw material polymer to form a rubber crosslinked product. The type of crosslinking agent is not particularly limited as long as it is any crosslinking agent known to those skilled in the art to be added to the rubber crosslinked product. Examples of the crosslinking agent include organic peroxides, sulfur, sulfur compounds, oximes, nitroso compounds, polyamines, thiurams, and the like. The crosslinking agent may be added alone, or may be added in combination of two or more thereof.

The content of the crosslinking agent may also be appropriately adjusted within a range without impairing the effect on dynamic viscoelasticity from a low frequency to a high frequency in the present embodiment. For example, when the rubber crosslinked product contains a crosslinking agent, the content of the crosslinking agent is preferably 3.0 parts by mass or more and 10 parts by mass or less, and more preferably 5.0 parts by mass or more and 9.0 parts by mass or less, with respect to 100 parts by mass of the rubber component.

The crosslinking aid has a function of accelerating the formation of a crosslinked structure by a crosslinking agent or a vulcanizing agent. The type of the crosslinking aid is not particularly limited as long as it is any crosslinking aid known to those skilled in the art to be added to the rubber crosslinked product. Examples of the crosslinking aid include phenylenedimaleimide, quinone dioxime, ammonium benzoate, nitrosobenzenes, morpholine disulfide, and the like. The crosslinking aid may be added alone, or may be added in combination of two or more thereof.

The content of the crosslinking aid may also be appropriately adjusted within a range without impairing the effect on dynamic viscoelasticity from a low frequency to a high frequency in the present embodiment. For example, when the rubber crosslinked product contains a crosslinking aid, the content of the crosslinking aid is preferably 0.3 parts by mass or more and 3.0 parts by mass or less, and more preferably 0.5 parts by mass or more and 1.5 parts by mass or less, with respect to 100 parts by mass of the rubber component.

The oil has a function as a softener. The type of oil is not particularly limited as long as it is any oil known to those skilled in the art to be added to the rubber crosslinked product. Examples of the oil include process oils such as paraffinic oils and naphthenic oils, vegetable oils, synthetic oils such as alkylbenzene oils, castor oil, and the like. The oil may be added alone, or may be added in combination of two or more thereof.

The content of the oil may also be appropriately adjusted within a range without impairing the effect on dynamic viscoelasticity from a low frequency to a high frequency in the present embodiment. For example, when the rubber crosslinked product contains oil, the content of the oil is preferably 5 parts by mass or more and 150 parts by mass or less, and more preferably 10 parts by mass or more and 120 parts by mass or less, with respect to 100 parts by mass of the rubber component.

In addition to the above components, the rubber crosslinked product can appropriately contain any additives generally used in the rubber industry field, such as fillers (for example, talc, silica, and the like), waxes, plasticizers, antioxidants, foaming agents, lubricants, tackifiers, petroleum-based resins, ultraviolet absorbers, dispersants, compatibilizers, homogenizing agents, vulcanization retarders, silica, and silane coupling agents, within a range without impairing the effect on dynamic viscoelasticity from a low frequency to a high frequency in the present embodiment.

When the optional component is contained, the total content thereof is preferably more than 0 parts by mass and 200 parts by mass or less, more preferably 5 parts by mass or more and 160 parts by mass or less, further preferably 10 parts by mass or more and 132 parts by mass or less, and particularly preferably 15 parts by mass or more and 125 parts by mass or less, with respect to 100 parts by mass of the rubber component.

### (Physical Properties of Rubber Crosslinked Product)

The storage modulus in the grain direction of the rubber crosslinked product according to the present embodiment is preferably 1.1 times or more and 6.0 times or less the storage modulus in the opposite grain direction. The larger the storage modulus in the grain direction with respect to the storage modulus in the opposite grain direction of the rubber crosslinked product, the higher the elastic modulus and the higher the durability of the rubber crosslinked product.

When the PET fibers having a high aspect ratio are present in substantially parallel as much as possible while being dispersed (preferably substantially uniformly dispersed) in the rubber crosslinked product, the storage modulus in the grain direction with respect to the storage modulus in the opposite grain direction of the rubber crosslinked product can be increased. When the shape of the rubber crosslinked product according to the present embodiment is a sheet shape, a rod shape, or the like, a plurality of PET fibers can be easily placed in such an arrangement in the rubber crosslinked product.

As described above, the rubber crosslinked product according to the present embodiment has a high storage modulus and a low loss factor from the low frequency range to the high frequency range. Therefore, according to the vibration-proof member including the rubber crosslinked product according to the present embodiment, good steering stability can be obtained regardless of the frequency, and the vibration-proof member can be suitably used for various members requiring vibration-proof properties.

### <Method for Producing Rubber Crosslinked Product>

In a method for producing the rubber crosslinked product according to the present embodiment, as raw materials, the rubber component, carbon black as an optional component and other optional components, and composite material composed of polyethylene and a plurality of PET fibers described above are used.

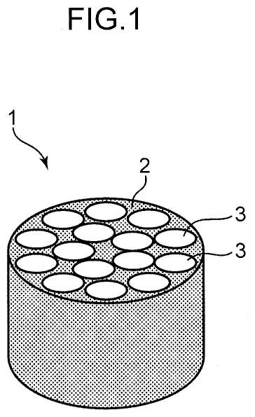

FIG. 1 shows a schematic view of a composite material composed of polyethylene and a plurality of PET fibers as raw materials of a rubber crosslinked product according to the present embodiment. In FIG. 1, each reference sign indicates composite material 1, polyethylene 2, and PET fiber 3, respectively. As shown in FIG. 1, the composite material 1 has a sea-island structure including polyethylene 2 and a plurality of PET fibers 3. As described above, the PET fiber 3 has a diameter of 100 nm or more and 1000 nm or less and a length of 0.1 mm or more and 50 mm or less. The rubber crosslinked product according to the embodiment described above can be obtained by kneading a composite material of such polyethylene and PET fibers instead of directly mixing PET fibers as raw materials during kneading the rubber. Specifically, the polyethylene of the composite material is melted by heating during rubber kneading, and at the same time, the PET fibers are well dispersed (preferably, substantially uniformly dispersed) in the rubber crosslinked product.

The rubber crosslinked product according to the embodiment described above can be produced by any method for producing a rubber crosslinked product known to those skilled in the art using these raw materials. Hereinafter, an example of a method for producing the rubber crosslinked product according to the present embodiment will be described.

### (Preparation of Raw Materials)

First, the rubber component, composite material composed of polyethylene and a plurality of PET fibers, carbon black as an optional component, and other optional components described above are weighed so as to have the content ratio in each of the rubber crosslinked products described above.

### (Primary Kneading)

Subsequently, raw materials such as a rubber component and a composite material composed of polyethylene and a plurality of PET fibers, excluding a crosslinking agent and a crosslinking aid, are kneaded using any kneader known to those skilled in the art (also referred to as “primary kneading”). The kneader is not particularly limited, and examples thereof include a Banbury mixer, an internal mixer, a roll, and the like. The kneading temperature at this time may be appropriately set according to the type of the rubber component, the blending ratio amount of each component to be kneaded, and the like, and for example, the start temperature may be 40° C. to 90° C., and the kneading end temperature may be 100° C. to 160° C. The kneading time may also be appropriately set according to the type of the rubber component, the blending ratio amount of each component to be kneaded, and the like, and may be, for example, about 3 minutes to 10 minutes.

### (Secondary Kneading)

Thereafter, the kneaded product after the primary kneading is masticated, a crosslinking agent and a crosslinking aid are then added thereto, and the kneaded product is further kneaded using a roll such as an open roll, a kneader, or the like (also referred to as “secondary kneading”). The kneading temperature at this time may be appropriately set according to the type of the rubber component, the blending ratio amount of each component to be kneaded, and the like, and can be, for example, 30° C. to 70° C. The kneading time may also be appropriately set according to the type of the rubber component, the blending ratio amount of each component to be kneaded, and the like, and may be, for example, about 5 minutes to 130 minutes.

### (Molding)

After the secondary kneading, the kneaded product is formed into a desired shape. Thereafter, the molded kneaded product is heated at, for example, 150° C. to 200° C. for 1 minute to 30 minutes, whereby the rubber crosslinked product having a desired shape according to the embodiment described above can be obtained.

### <Vibration-Proof Member>

The vibration-proof member according to the present embodiment includes the rubber crosslinked product according to the embodiment described above. Specifically, the vibration-proof member includes the rubber crosslinked product according to the embodiment described above molded into a desired shape. Therefore, the vibration-proof member according to the present embodiment can also have a high storage modulus and a low loss factor from the low frequency range to the high frequency range.

The type of the vibration-proof member is not particularly limited, but is preferably a vibration-proof member for a vehicle, in particular, for an automobile, which is required to have high vibration-proof performance. Specifically, examples of the vibration-proof member include vibration-proof rubbers for automobiles such as tires, bushes, engine mounts, torsional dampers, body mounts, cap mounts, member mounts, strut mounts, and muffler mounts, vibration-proof rubbers for railway vehicles, vibration-proof rubbers for industrial machines such as timing belts and conveyor belts, vibration-proof rubbers for buildings, and the like.

The present specification discloses various aspects of the technology as described above, and the main technologies are summarized below.

A rubber crosslinked product according to a first aspect of the present invention contains a rubber component containing one or more polymers of ethylene propylene diene rubber and ethylene butene diene rubber; polyethylene compatibilized with the rubber component; and a plurality of polyethylene terephthalate fibers having a diameter of 100 nm or more and 1000 nm or less and a length of 0.1 mm or more and 50 mm or less, in which a content of the polyethylene is 0.05 parts by mass or more and 5.0 parts by mass or less with respect to 100 parts by mass of the rubber component, and a total content of the plurality of polyethylene terephthalate fibers is 0.15 parts by mass or more and 5.0 parts by mass or less with respect to 100 parts by mass of the rubber component.

A rubber crosslinked product according to a second aspect of the present invention is the rubber crosslinked product according to the first aspect, in which a storage modulus of the rubber crosslinked product in the grain direction is 1.1 times or more and 6.0 times or less a storage modulus in the opposite grain direction.

A rubber crosslinked product according to a third aspect of the present invention is the rubber crosslinked product according to the first or second aspect, in which the rubber component contains one or more polymers selected from the group consisting of ethylene propylene 5-ethylidene-2-norbornene rubber, ethylene propylene vinylidene 5-vinyl-2-norbornene rubber, and ethylene butene 5-ethylidene-2-norbornene rubber.

A rubber crosslinked product according to a fourth aspect of the present invention is the rubber crosslinked product according to any one of the first to third aspects, further containing carbon black, and the content of the carbon black is 35 parts by mass or more and 200 parts by mass or less with respect to 100 parts by mass of the rubber component.

A rubber crosslinked product according to a fifth aspect of the present invention is the rubber crosslinked product according to any one of the first to fourth aspects, further containing one or more components selected from the group consisting of a vulcanization accelerator aid, a processing aid, an anti-aging agent, a vulcanization accelerator, a crosslinking agent, a crosslinking aid, a filler, and an oil.

A rubber crosslinked product according to a sixth aspect of the present invention is the rubber crosslinked product according to the fifth aspect, in which the total content of the one or more components is more than 0 parts by mass and 200 parts by mass or less with respect to 100 parts by mass of the rubber component.

A vibration-proof member according to a seventh aspect of the present invention includes the rubber crosslinked product according to any one of the first to sixth aspects.

A method for producing a rubber crosslinked product according to an eighth aspect of the present invention includes: primarily kneading raw materials including a rubber component containing one or more polymers of ethylene propylene diene rubber and ethylene butene diene rubber, and a composite material having a sea-island structure composed of polyethylene and a plurality of polyethylene terephthalate fibers having a diameter of 100 nm or more and 1000 nm or less and a length of 0.1 mm or more and 50 mm or less, masticating the kneaded product after the primary kneading, then adding a component that forms a crosslinked structure, and secondarily kneading the kneaded product, and molding the kneaded product after the secondary kneading to obtain a rubber crosslinked product, in which the content of the polyethylene in the rubber crosslinked product is 0.05 parts by mass or more and 5.0 parts by mass or less with respect to 100 parts by mass of the rubber component, and the total content of the plurality of polyethylene terephthalate fibers in the rubber crosslinked product is 0.15 parts by mass or more and 5.0 parts by mass or less with respect to 100 parts by mass of the rubber component.

A method for producing a rubber crosslinked product according to a ninth aspect of the present invention is the method for producing a rubber crosslinked product according to the eighth aspect, in which the rubber crosslinked product is the rubber crosslinked product according to any one of the first to sixth aspects.

### Example

Hereinafter, the present invention will be described more specifically with reference to Examples, but the present invention is not limited by Examples at all.

In the examples, a sheet-shaped rubber crosslinked product was actually produced, a sample was collected from the produced rubber crosslinked product, measurement of dynamic viscoelasticity and observation of the cross section of the sample of the rubber crosslinked product using a digital microscope were performed.

First, raw materials used for the production of the rubber crosslinked product in the examples are collectively shown below.

### <Raw Materials>

### [Rubber Components]

EPDM rubber 1: Ethylene propylene 5-ethylidene-2-norbornene rubber (“EP24” manufactured by ENEOS Materials Corporation, ethylene content: 54 wt %, Mooney viscosity at 125° C.: 42, polymer represented by the following formula (1))

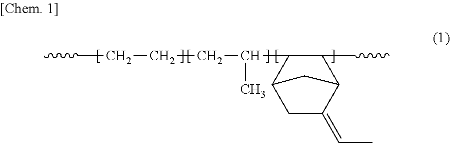

EPDM rubber 2: Ethylene propylene vinylidene 5-vinyl-2-norbornene rubber (“PX-008M” manufactured by Mitsui Chemicals, Inc., ethylene content: 60 wt %, Mooney viscosity at 125° C.: 46, polymer represented by the following formula (2))

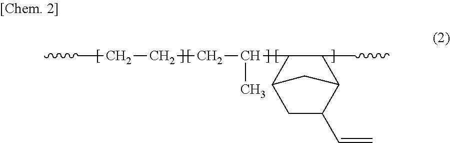

EBDM rubber: Ethylene butene 5-ethylidene-2-norbornene rubber (“K-9330M” manufactured by Mitsui Chemicals, Inc., ethylene content: 50 wt %, Mooney viscosity at 125° C.: 30, polymer represented by the following formula (3))

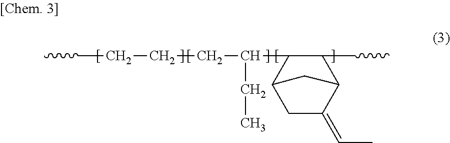

### [Composite Material]

Composite material composed of polyethylene and a plurality of PET fibers: “NANOFRONT (registered trademark)” (composite material having a sea-island structure of polyethylene and a plurality of PET fibers having a diameter of 700 nm and a length of 0.5 mm, polyethylene: PET fibers (mass ratio)=3:7) manufactured by TEIJIN LIMITED.

### [Other Components]

Zinc oxide (vulcanization accelerator aid): “Zinc flower 3” manufactured by SAKAI CHEMICAL INDUSTRY CO., LTD.
Stearic acid (processing aid): Manufactured by Lion Fat and Oil Co., Ltd.
FEF carbon black: “#60” manufactured by Asahi Carbon Co., Ltd.
Paraffinic oil: Diana process oil manufactured by Idemitsu Kosan Co., Ltd.
Anti-aging agent CD: “Nocrac CD” (amine-based anti-aging agent, 4,4′-bis(α,α-dimethylbenzyl)diphenylamine) manufactured by Ouchi Shinko Chemical Industrial Co., Ltd.
Anti-aging agent MB: “Nocrac MB” (imidazole-based anti-aging agent, 2-mercaptobenzimidazole) manufactured by Ouchi Shinko Chemical Industrial Co., Ltd.
Organic peroxide (dicumyl peroxide) (crosslinking agent): “DCP40” manufactured by NOF CORPORATION
Crosslinking aid: “Vulnoc PM” manufactured by Ouchi Shinko Chemical Industrial Co., Ltd.

Next, a method for producing a rubber crosslinked product common to Examples and Comparative Examples will be described below.

### <Method for Producing Rubber Crosslinked Product>

In Examples and Comparative Examples, first, the materials upon primary kneading at the blending ratio (parts by mass) shown in Table 1 below were kneaded for 6 minutes to 7 minutes using a Banbury mixer (“Labo Plastomill” manufactured by Toyo Seiki Seisaku-sho, Ltd.) under the conditions of a start temperature of 75° C. to 80° C. and a dump (kneading end) temperature of 140° C. to 150° C. Next, the kneaded product after the primary kneading was masticated at a roll temperature of 40° C. for 0.5 minutes to 1 minute. Thereafter, materials upon secondary kneading having a blending ratio (parts by mass) shown in Table 1 were added to the kneaded product, and the mixture was kneaded again for 10 minutes to form a sheet. Thereafter, a sheet-shaped rubber crosslinked product was finally produced by molding at 170° C.

TABLE 1

| | | | | | | Compar- | Compar- | Compar- |
|---|---|---|---|---|---|---|---|---|
| | | | | | | ative | ative | ative |
| | | | Example 1 | Example 2 | Example 3 | Example 1 | Example 2 | Example 3 |
| Materials upon primary kneading | Rubber | EPDM rubber 1 | 100 | — | — | 100 | — | — |
| (parts by mass with respect to 100 parts | components | EPDM rubber 2 | — | 100 | — | — | 100 | — |
| by mass of rubber component) | | EBDM rubber | — | — | 100 | — | — | 100 |

| | | | | | | | |
|---|---|---|---|---|---|---|---|
| | Composite material of | 4.0 | 4.0 | 4.0 | — | — | — |
| | polyethylene and PET fiber | | | | | | |
| | Zinc oxide | 5.0 | 5.0 | 5.0 | 5.0 | 5.0 | 5.0 |
| | Stearic acid | 1.0 | 1.0 | 1.0 | 1.0 | 1.0 | 1.0 |
| | FEF carbon black | 115 | 110 | 50 | 115 | 110 | 50 |
| | Paraffinic oil | 110 | 55 | — | 110 | 55 | — |
| | Anti-aging agent CD | — | 1.5 | 1.5 | — | 1.5 | 1.5 |
| | Anti-aging agent MB | — | 3.0 | 3.0 | — | 3.0 | 3.0 |
| Materials upon secondary kneading | Organic peroxide | 7.0 | 7.0 | 7.0 | 7.0 | 7.0 | 7.0 |
| (parts by mass with respect to 100 parts | Crosslinking aid | 1.0 | — | — | 1.0 | — | — |
| by mass of rubber component) | | | | | | | |

In Table 1 above, “-” indicates that it is not contained in the raw materials of the rubber crosslinked product.

The following measurement was performed using the sheet-shaped rubber crosslinked products of Examples and Comparative Examples produced by the method described above. Furthermore, the following observation was also performed using the rubber crosslinked product of Example 3.

### <Measurement of Dynamic Viscoelasticity of Rubber Crosslinked Product>

The dynamic viscoelasticity, specifically, the storage modulus (Pa) and the loss factor (tan δ) of the rubber crosslinked products of Examples and Comparative Examples were measured by the following method. First, two samples in the grain direction and the opposite grain direction of the size of the JIS No. 3 dumbbell were cut out from the sheet-shaped rubber crosslinked products of Examples and Comparative Examples produced. The grain direction is a direction in which the length direction of the sample is parallel to the length direction of the plurality of PET fibers arranged substantially in parallel. The opposite grain direction is a direction in which the length direction of the sample is perpendicular to the length direction of the plurality of PET fibers arranged substantially in parallel. Next, using the two cut samples, the storage modulus (Pa) and the loss factor (tan δ) at a frequency of 0 Hz to 400 Hz (0 Hz to 200 Hz in Example 1 and Comparative Example 1) were measured by a viscoelasticity tester manufactured by UBM under the following measurement conditions of the dynamic viscoelasticity test.

### (Measurement Conditions of Dynamic Viscoelasticity Test)

Measurement method: Dynamic viscoelasticity measurement (sine wave)·
Measurement mode: Frequency dependence (0 Hz to 400 Hz, provided that 0 Hz to 200 Hz in Example 1 and Comparative Example 1)
Chuck: Pull
Waveform: Sine wave
Type of excitation: Continuous excitation
Conditions: Distortion control 40 μm
Measurement temperature: Room temperature

### Results and Discussion

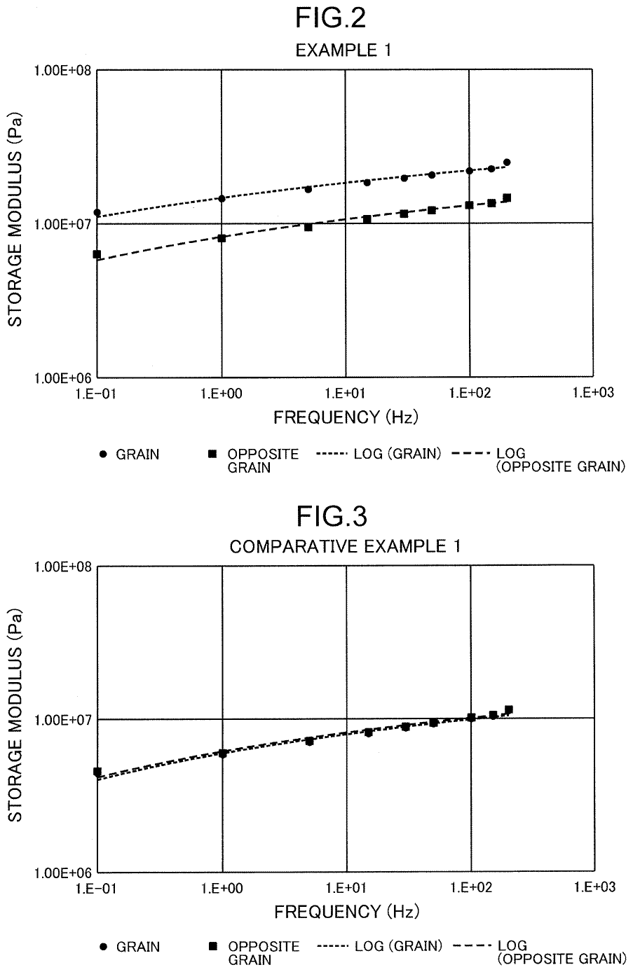

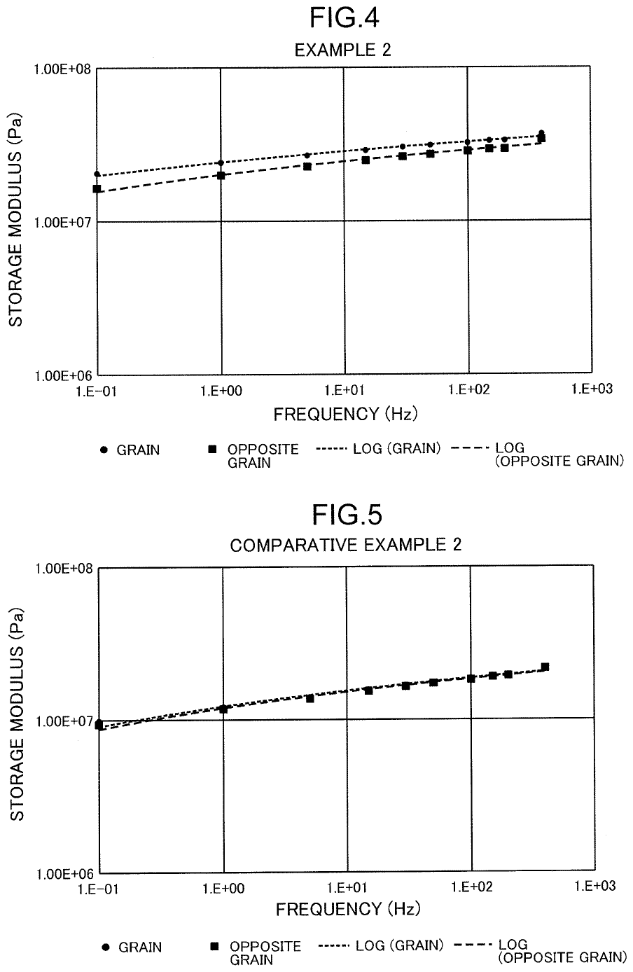

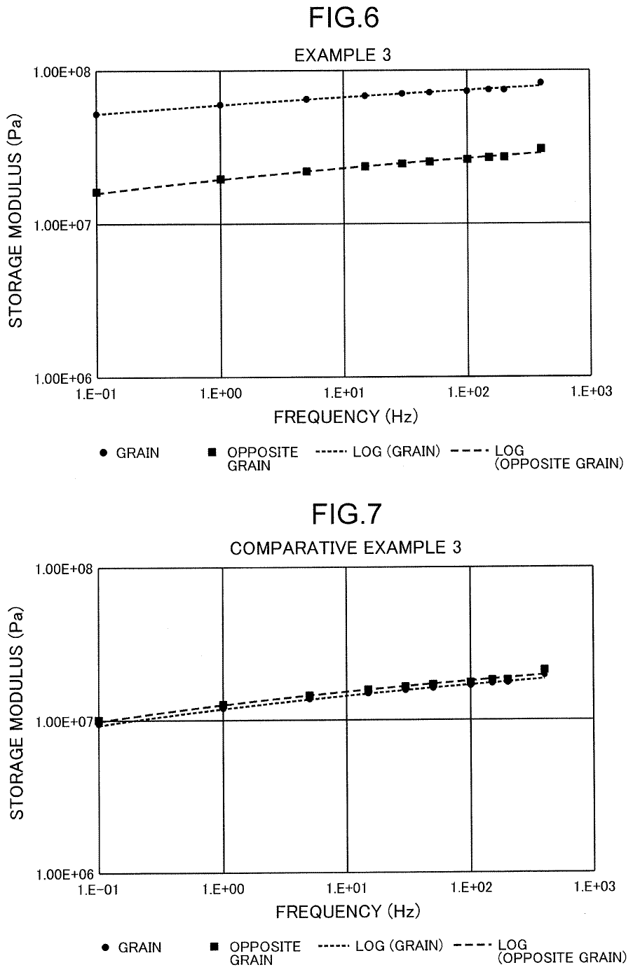

FIGS. 2 to 7 each show a graph of the storage moduli of the samples of the rubber crosslinked product of each of Examples 1 to 3 and Comparative Examples 1 to 3 in the grain direction and the opposite grain direction at each frequency. As can be seen from the comparison between FIG. 2 and FIG. 3, the comparison between FIG. 4 and FIG. 5, and the comparison between FIG. 6 and FIG. 7, in any of the rubber crosslinked products of Examples 1 to 3 in which 4 parts by mass of the composite material of polyethylene and PET fibers (polyethylene: PET fibers (mass ratio)=3:7) was added as a material upon primary kneading, the storage modulus of the sample in the grain direction was remarkably improved with respect to the storage modulus of the sample in the opposite grain direction from the low frequency range to the high frequency range. Specifically, in the rubber crosslinked products of Examples 1 to 3, the storage modulus in the grain direction with respect to the storage modulus in the opposite grain direction was 1.1 times at the smallest site, and 6.0 times at the largest site. The smallest site is a measurement site at a frequency of around 100 Hz in the rubber crosslinked product of Example 1, and the largest site is a measurement site at a frequency of around 100 Hz in the rubber crosslinked product of Example 3.

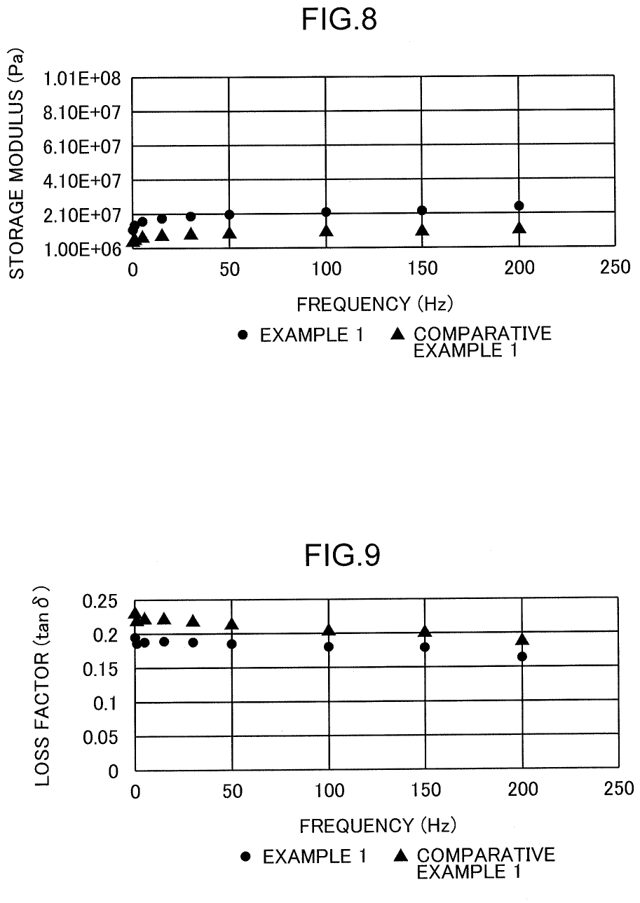

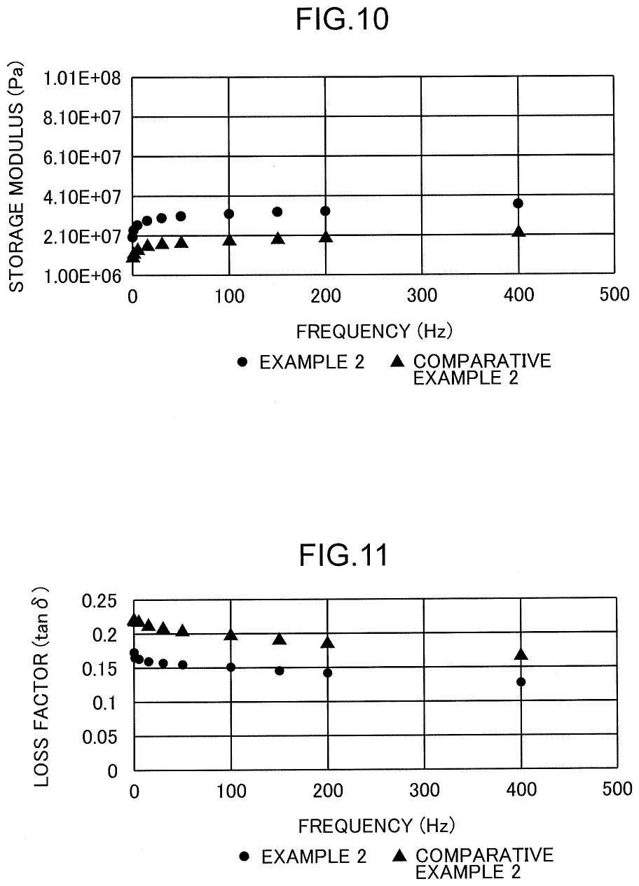

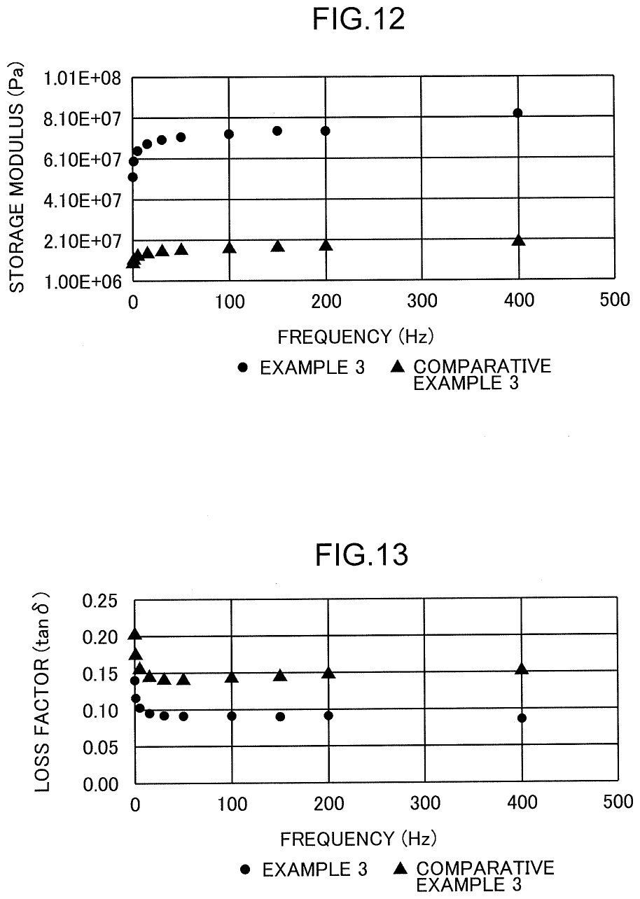

Further, FIGS. 8 and 9 each show a graph of comparison of the storage moduli (FIG. 8) or the loss factors (FIG. 9) of the samples of the rubber crosslinked product of Example 1 and the rubber crosslinked product of Comparative Example 1 in the grain direction at each frequency. FIGS. 10 and 11 each show a graph of comparison of the storage moduli (FIG. 10) or the loss factors (FIG. 11) of the samples of the rubber crosslinked product of Example 2 and the rubber crosslinked product of Comparative Example 2 in the grain direction at each frequency. FIGS. 12 and 13 each show a graph of comparison of the storage moduli (FIG. 12) or the loss factors (FIG. 13) of the samples of the rubber crosslinked product of Example 3 and the rubber crosslinked product of Comparative Example 3 in the grain direction at each frequency. As can be seen from the comparison between these graphs, in all of the rubber crosslinked products of Examples 1 to 3 in which 4 parts by mass of the composite material of polyethylene and PET fibers was added as the material upon primary kneading, the storage modulus was improved and the loss factor was decreased from the low frequency range to the high frequency range.

From the above results shown in FIGS. 2 to 13, it can be seen that a rubber crosslinked product having a high storage modulus and a low loss factor from the low frequency range to the high frequency range can be obtained by using a composite material composed of polyethylene and a plurality of PET fibers having an extremely small diameter as raw materials and adding the composite material such that the content ratio between polyethylene and the PET fibers in the finally obtained rubber crosslinked product has a predetermined value, regardless of the type of rubber component of EPDM or EBDM. Since the rubber crosslinked product according to the present embodiment thus produced has good steering stability, it is assumed that the rubber crosslinked product is suitably used for vibration-proof applications such as a part of a vibration-proof member.

### <Observation of Cross Section of Sample of Rubber Crosslinked Product Using Digital Microscope>

Using the rubber crosslinked product of Example 3, the cross section of a sample of the rubber crosslinked product was observed by the following method. First, a 5 cm square×2 mm thick sample was cut out from an arbitrary site from the produced rubber crosslinked product of Example 3. Thereafter, the cross section of the cut sample was observed at 500 times using a digital microscope “VHX-8000” manufactured by KEYENCE CORPORATION.

### Results

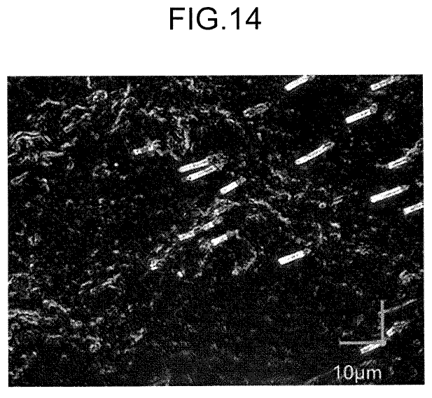

FIG. 14 shows a part of a cross-sectional image of the sample of the rubber crosslinked product of Example 3 observed using the digital microscope. As shown in FIG. 14, in the composite material of polyethylene and PET fibers as raw materials, the polyethylene could not be finally distinguished from the rubber component, and was compatibilized with the rubber component. In addition, as shown in FIG. 14, the plurality of PET fibers having an extremely small diameter were not aggregated in the rubber component and the polyethylene, but were dispersed and spread throughout the rubber component and the polyethylene.

This application is based on Japanese Patent application No. 2024-212028 filed in Japan Patent Office on Dec. 5, 2024, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A rubber crosslinked product comprising:
a rubber component containing one or more polymers of ethylene propylene diene rubber and ethylene butene diene rubber; polyethylene compatibilized with the rubber component;
and a plurality of polyethylene terephthalate fibers having a diameter of 100 nm or more and 1000 nm or less and a length of 0.1 mm or more and 50 mm or less,
wherein a content of the polyethylene is 0.05 parts by mass or more and 5.0 parts by mass or less with respect to 100 parts by mass of the rubber component, and
a total content of the plurality of polyethylene terephthalate fibers is 0.15 parts by mass or more and 5.0 parts by mass or less with respect to 100 parts by mass of the rubber component.

2. The rubber crosslinked product according to claim 1, wherein a storage modulus of the rubber crosslinked product in the grain direction is 1.1 times or more and 6.0 times or less a storage modulus in the opposite grain direction.

3. The rubber crosslinked product according to claim 1, wherein the rubber component contains one or more polymers selected from the group consisting of ethylene propylene 5-ethylidene-2-norbornene rubber, ethylene propylene vinylidene 5-vinyl-2-norbornene rubber, and ethylene butene 5-ethylidene-2-norbornene rubber.

4. The rubber crosslinked product according to claim 1, further comprising carbon black, wherein a content of the carbon black is 35 parts by mass or more and 200 parts by mass or less with respect to 100 parts by mass of the rubber component.

5. The rubber crosslinked product according to claim 1, further comprising one or more components selected from the group consisting of a vulcanization accelerator aid, a processing aid, an anti-aging agent, a vulcanization accelerator, a crosslinking agent, a crosslinking aid, a filler, and an oil.

6. The rubber crosslinked product according to claim 5, wherein a total content of the one or more components is more than 0 parts by mass and 200 parts by mass or less with respect to 100 parts by mass of the rubber component.

7. A vibration-proof member comprising the rubber crosslinked product according to claim 1.
